(19) United States
(12) Patent Application Publication
(10) Pub. No.: US 2026/0312269 A1
(43) Pub. Date: Oct. 8, 2026

(54) WAVEGUIDE CABLE CONFIGURATIONS

(71) Applicant: Molex, LLC, Lisle, IL (US)

(72) Inventors: Todd D. Ward, Maumelle, AR (US); Michael McGee, Maumelle, AR (US); Karla De Brae Zadoorian, Sherwood, AR (US); Augusto P. Panella, Naperville, IL (US); Joseph Faia, Fox Lake, IL (US)

(21) Appl. No.: 19/578,895

(22) Filed: Mar. 26, 2026

Related U.S. Application Data
(60) Provisional application No. 63/785,017, filed on Apr. 8, 2025.

(51) Int. Cl. H01P 3/16

(52) U.S. Cl. CPC H01P 3/16

(57) ABSTRACT

Waveguides, waveguide cables, waveguide cable configurations, ribboned waveguide cable configurations, and related cables and methods are described herein. An example waveguide cable includes a first dielectric core, a second dielectric core, a first boundary structure positioned and extending along an interface between the first dielectric core and the second dielectric core, a second boundary structure positioned and extending along the interface between the first dielectric core and the second dielectric core, and a cover layer that extends around the second dielectric core. The first boundary structure comprises a first flat wire and the second boundary structure comprises a second flat wire in one example. An example ribboned waveguide cable includes a first waveguide cable, a second waveguide cable, and a cover layer that extends over the waveguide cables. The cover layer can include a conductive metal layer and ribbonize the waveguide cables.

### BACKGROUND

The amount of data processed by computing, network switching, telecommunications, and related systems continues to increase. Data centers can include hundreds or thousands of networking and computing systems. The systems can be interconnected by Copper, optical, and other types of cables, and various connectors, adapters, and terminations between them. The data throughput of the interconnect systems is high and increasing. A range of different input/output (I/O) connectors, cables, cable assemblies, and interconnect systems are designed for data, power, and data and power interconnects in data centers and related system applications.

Example interconnect systems include board-to-board, wire-to-wire, and wire-to-board systems. A variety of designs exist for each type of cable, cable assembly, connector, and interconnect system, depending on the requirements of the power and data communications environment in which the cables, cable assemblies, and interconnect systems are used. As one example, a wire-to-board system includes a free-end connector attached to a cable bundle of wires and a fixed-end connector attached to a printed circuit board (PCB). Wire-to-board systems can also be implemented by directly connecting the end of a cable to a PCB, often proximate to a processing chip.

### SUMMARY

Aspects and embodiments of waveguides, waveguide cables, waveguide cable configurations, ribboned waveguide cable configurations, and related cables and methods are described. An example waveguide cable includes a first dielectric core, a second dielectric core, a first boundary structure positioned and extending along an interface between the first dielectric core and the second dielectric core, a second boundary structure positioned and extending along the interface between the first dielectric core and the second dielectric core, and a cover layer that extends around the second dielectric core. Along a length of the waveguide cable, the second dielectric core extends entirely around the first dielectric core in at least some embodiments. In one example, the first boundary structure includes a first flat wire, and the second boundary structure includes a second flat wire. The cover layer can also include a conductive metal layer in some cases.

In aspects of the embodiments, the first boundary structure includes a first planar surface and the second boundary structure includes a second planar surface. The first boundary structure extends along a first interface region between the first dielectric core and the second dielectric core, the second boundary structure extends along a second interface region between the first dielectric core and the second dielectric core, and an inner surface of the first boundary structure faces an inner surface of the second boundary structure.

In other aspects, the first dielectric core includes a first dielectric material having a first dielectric constant, the second dielectric core includes a second dielectric material having a second dielectric constant, and the first dielectric constant is different than the second dielectric constant. The first dielectric core can include a first dielectric material having a first dielectric constant, the second dielectric core can include a second dielectric material having a second dielectric constant, and the first boundary structure and the second boundary structure can include a third dielectric material having a third dielectric constant. The first dielectric constant can be different than the second dielectric constant, and the third dielectric constant can be greater than the first dielectric constant and the second dielectric constant.

In other aspects, the first dielectric core includes a first dielectric material having a first dielectric constant, the second dielectric core includes a second dielectric material having a second dielectric constant, and the cover layer includes a third dielectric material having a third dielectric constant. The first dielectric constant can be different than the second dielectric constant, and the third dielectric constant can be greater than the first dielectric constant and the second dielectric constant.

An example ribboned waveguide cable includes a first waveguide cable, a second waveguide cable, and a cover layer that extends over the first waveguide cable and the second waveguide cable. The first waveguide cable includes a first dielectric core, a second dielectric core, a first boundary structure positioned and extending along an interface between the first dielectric core and the second dielectric core, and a second boundary structure positioned and extending along the interface between the first dielectric core and the second dielectric core. In one example, the cover layer includes a conductive metal layer, and the cover layer ribbonizes the first waveguide cable and the second waveguide cable.

The ribboned waveguide cable can also include a third waveguide cable. The cover layer can extends over the first waveguide cable, the second waveguide cable, and the third waveguide cable. The ribboned waveguide cable can also include a drain conductor between the first waveguide cable and the second waveguide cable. The cover layer can extend over the first waveguide cable, the drain conductor, and the second waveguide cable.

In other aspects of the ribboned waveguide cable, the first boundary structure extends along a first interface region between the first dielectric core and the second dielectric core, the second boundary structure extends along a second interface region between the first dielectric core and the second dielectric core, and an inner surface of the first boundary structure faces an inner surface of the second boundary structure. In other aspects, the first boundary structure includes a first flat wire, and the second boundary structure comprises a second flat wire.

Another ribboned waveguide cable includes a first waveguide cable, a second waveguide cable, and a cover layer that extends over the first waveguide cable and the second waveguide cable. The first waveguide cable can include a first dielectric core, a second dielectric core, and first and second boundary structures positioned and extending within the first dielectric core. The cover layer can include a conductive metal layer, and the cover layer ribbonizes the first waveguide cable and the second waveguide cable. The ribboned waveguide cable can also include a drain conductor between the first waveguide cable and the second waveguide cable. The cover layer can extend over the first waveguide cable, the drain conductor, and the second waveguide cable.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, the same reference numeral designates corresponding, but not necessarily the same, part or component throughout the views.

FIG. 1A illustrates a perspective view of an example waveguide cable according to various embodiments of the present disclosure.

FIG. 1B illustrates another perspective view of the waveguide cable shown in FIG. 1A according to various embodiments of the present disclosure.

FIG. 1C illustrates an end view of the waveguide cable shown in FIG. 1A according to various embodiments of the present disclosure.

FIG. 2A illustrates an end view of another waveguide cable according to various embodiments of the present disclosure.

FIG. 3A illustrates an end perspective view of a ribboned waveguide cable according to various embodiments of the present disclosure.

FIG. 3B illustrates a top view of the ribboned waveguide cable shown in FIG. 3A according to various embodiments of the present disclosure.

FIG. 3C illustrates an end perspective view of another ribboned waveguide cable according to various embodiments of the present disclosure.

FIG. 3D illustrates an end perspective view of another ribboned waveguide cable according to various embodiments of the present disclosure.

FIG. 3E illustrates an end view of another ribboned waveguide cable according to various embodiments of the present disclosure.

FIG. 4A illustrates a perspective view of another waveguide cable according to various embodiments of the present disclosure.

FIG. 4B illustrates an end view of the waveguide cable shown in FIG. 1A according to various embodiments of the present disclosure.

FIG. 5 illustrates an end view of another waveguide cable according to various embodiments of the present disclosure.

FIG. 6 illustrates an end view of another waveguide cable according to various embodiments of the present disclosure.

FIG. 7A illustrates an end view of another ribboned waveguide cable according to various embodiments of the present disclosure.

FIG. 7B illustrates an end view of another ribboned waveguide cable according to various embodiments of the present disclosure.

### DETAILED DESCRIPTION

As noted above, the amount of data processed by computers, computing systems, and computing environments continues to increase. Data centers can include hundreds or thousands of networking and computing systems that are interconnected using optical cables, Copper cables, and various connectors and terminations therebetween. Data is often carried on these cables using radio frequency (RF) signals at microwave frequencies. A range of different interconnection techniques can be relied upon in data centers, such as die-to-die, die-to-optical engine, chip-to-module, chip-to-chip on the same printed circuit board (PCB), chip-to-chip on different PCBs, and other interconnections. To achieve higher throughputs, some interface technologies use direct attach Copper cable (DAC) interconnect solutions.

Data signals can be communicated and propagated over cables using a number of different modulation and signal propagation techniques, and data cables are often tailored based on the data rates, signal frequencies, modulation technique, propagation mode, and other signaling characteristics used for data communication. As examples, twisted pair cables, twinax cables, coaxial cables, and many other cables including electrical conductors typically transport or propagate data signal energy in transverse electromagnetic (TEM) mode. Waveguides, on the other hand, typically transport or propagate data signal energy in either transverse electric (TE) or transverse magnetic (TM) mode, and some data communication techniques specify the use of waveguides to communicate data on RF signals at microwave frequencies.

A number of waveguides, waveguide cables, waveguide cable configurations, ribboned waveguide cable configurations, and related methods are described herein. Waveguides, waveguide cables, waveguide cable configurations, ribboned waveguide cable configurations, and related cables and methods are described herein. An example waveguide cable includes a first dielectric core, a second dielectric core, a first boundary structure positioned and extending along an interface between the first dielectric core and the second dielectric core, a second boundary structure positioned and extending along the interface between the first dielectric core and the second dielectric core, and a cover layer that extends around the second dielectric core. The first boundary structure comprises a first flat wire and the second boundary structure comprises a second flat wire in one example. An example ribboned waveguide cable includes a first waveguide cable, a second waveguide cable, and a cover layer that extends over the waveguide cables. The cover layer can include a conductive metal layer and ribbonize the waveguide cables.

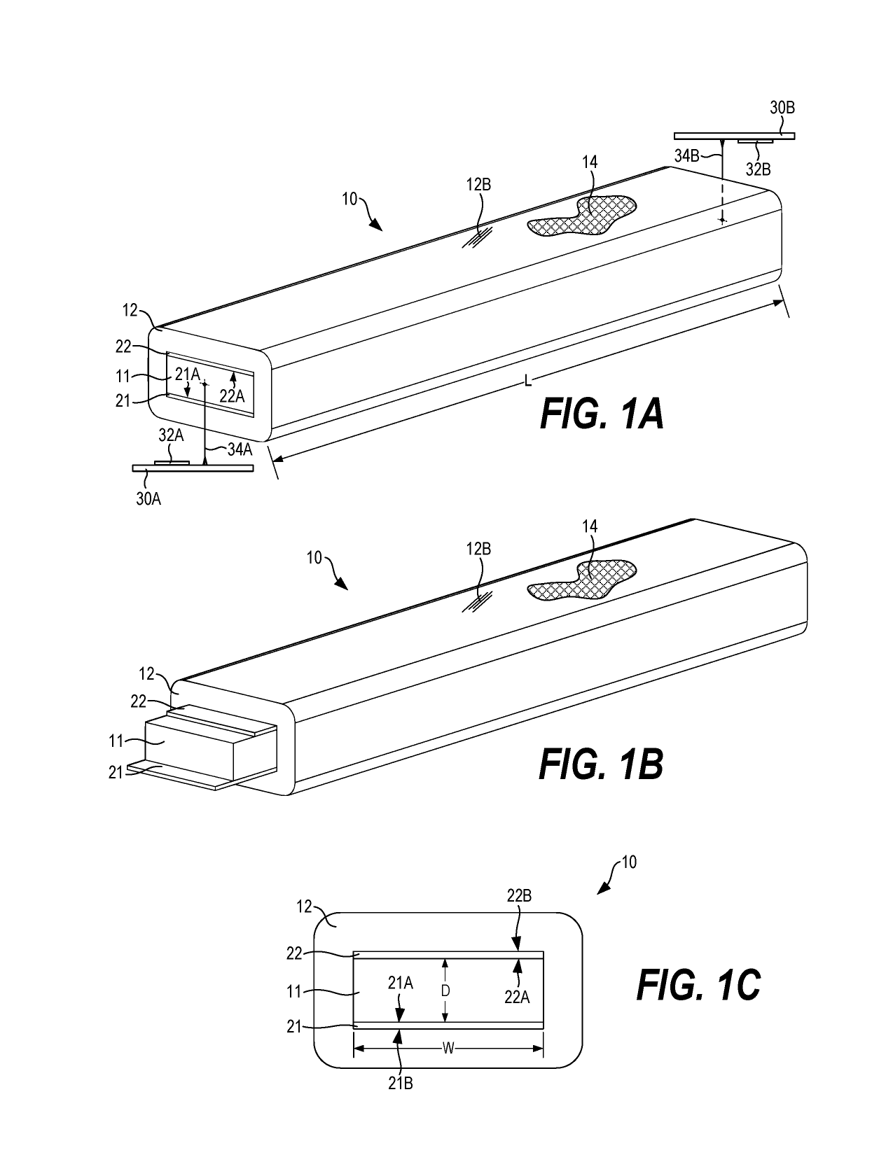

Turning to the drawings, FIG. 1A illustrates a perspective view of an example waveguide cable 10 (also “cable 10”) according to various embodiments of the present disclosure. FIG. 1B illustrates another perspective view of the cable 10 shown in FIG. 1A, and FIG. 1C illustrates an end view of the cable 10. The cable 10 is provided as an example of an electrical interconnect capable of data transmission. The cable 10 is particularly designed for the propagation of data carried on (e.g., modulated on) RF signals at relatively high frequencies, including microwave frequencies, but the cable 10 is not limited to use with any particular type of signal(s). The cable 10 is illustrated as a representative example and is not drawn to any particular scale or size. The shape, size, proportion, and other characteristics of the cable 10 can vary as compared to that shown. For example, the thicknesses of the boundary structures, the relative sizes or thicknesses of the dielectric cores, and other characteristics of the cable 10 can vary as compared to that shown. The cable 10 can also be formed to any suitable length “L” (see FIG. 1A). Additionally, in some cases, one or more parts or components of the cable 10 can be omitted. The cable 10 can also include other parts or components that are not illustrated in FIGS. 1A-1C, such as a shield layer, an outer insulating jacket, and/or possibly or other components in some cases.

Referring among FIGS. 1A-1C, the cable 10 includes a first dielectric core 11, a second dielectric core 12, and a pair of boundary structures. The pair of boundary structures includes a first boundary structure 21 and a second boundary structure 22. The boundary structure 21 extends along a first interface region between the first dielectric core 11 and the second dielectric core 12. The boundary structure 22 extends along a second interface region between the first dielectric core 11 and the second dielectric core 12. The second dielectric core 12 extends around the boundary structures 21 and 22 and around the first dielectric core 11. Stated differently, along the length “L” of the cable 10, the second dielectric core 12 extends entirely around the boundary structures 21 and 22 and the first dielectric core 11.

The first dielectric core 11 can be embodied as a first dielectric insulating material. As examples, the first dielectric core 11 can be embodied as solid polyolefin, low-density polyolefin, polypropylene, polyethylene (PE), PE foam, polytetrafluoroethylene (PTFE), fluoropolymer, or other dielectric insulating material. More generally, the first dielectric core 11 can be embodied as an electrical insulator that polarizes in the presence of an electric field. Electric charge does not flow through but instead shifts (i.e., polarizes) in the first dielectric core 11 when it is positioned within an electric field. Example dielectric constants (Dk) of the first dielectric core 11 can range from 1.5-6, and dielectric insulating materials having other Dk values can be relied upon.

The second dielectric core 12 can be embodied as a second dielectric insulating material. As examples, the second dielectric core 12 can be embodied as a solid or low-density polyolefin, polypropylene, PE, PE foam, PTFE, fluoropolymer, or other dielectric insulating material. Example dielectric constants of the second dielectric core 12 can range from 1.5-6 or more, and dielectric insulating materials having other Dk values can be relied upon. In some cases, the melting point of the second dielectric core 12 can be lower than the melting point of the first dielectric core 11, for manufacturing or other purposes, as described in further detail below.

In at least one preferred embodiment, the first dielectric insulating material of the first dielectric core 11 is a different material than the second dielectric insulating material of the second dielectric core 12. The dielectric constant of the first dielectric core 11, Dk₁₁, is also different than the dielectric constant of the second dielectric core 12, Dk₁₂, in that case. Dk₁₁ of the first dielectric core 11 can be greater than Dk₁₂ of the second dielectric core 12. As examples, Dk₁₁ can have a value between 3.5-6 and Dk₁₂ can have a value between 1.5-3, and other Dk values are within the scope of the embodiments. In other examples, the first and second dielectric materials can be selected such that Dk₁₁ of the first dielectric core 11 is greater than 1.5 times (i.e., 1.5x ) Dk₁₂ of the second dielectric core 12, greater than 2x, greater than3x, or more.

However, in other cases, Dk₁₁of the first dielectric core 11 can be less than Dk₁₂ of the second dielectric core 12. As examples, Dk₁₁ can have a value between 1.5-3 and Dk₁₂ can have a value between 3.5-6, and other Dk values are within the scope of the embodiments. The first and second dielectric materials can be selected such that Dk₁₂of the second dielectric core 12 is greater than 1.5 times (i.e., 1.5x ) Dk₁₁ of the first dielectric core 11, greater than 2x, greater than 3x, or more. In other cases, the first dielectric insulating material of the first dielectric core 11 can be the same material as the second dielectric insulating material of the second dielectric core 12, and Dk₁₁ can be the same as Dk₁₂. In still other cases, the first dielectric insulating material of the first dielectric core 11 can be the same material as the second dielectric insulating material of the second dielectric core 12, and Dk₁₁ can be different than Dk₁₂.

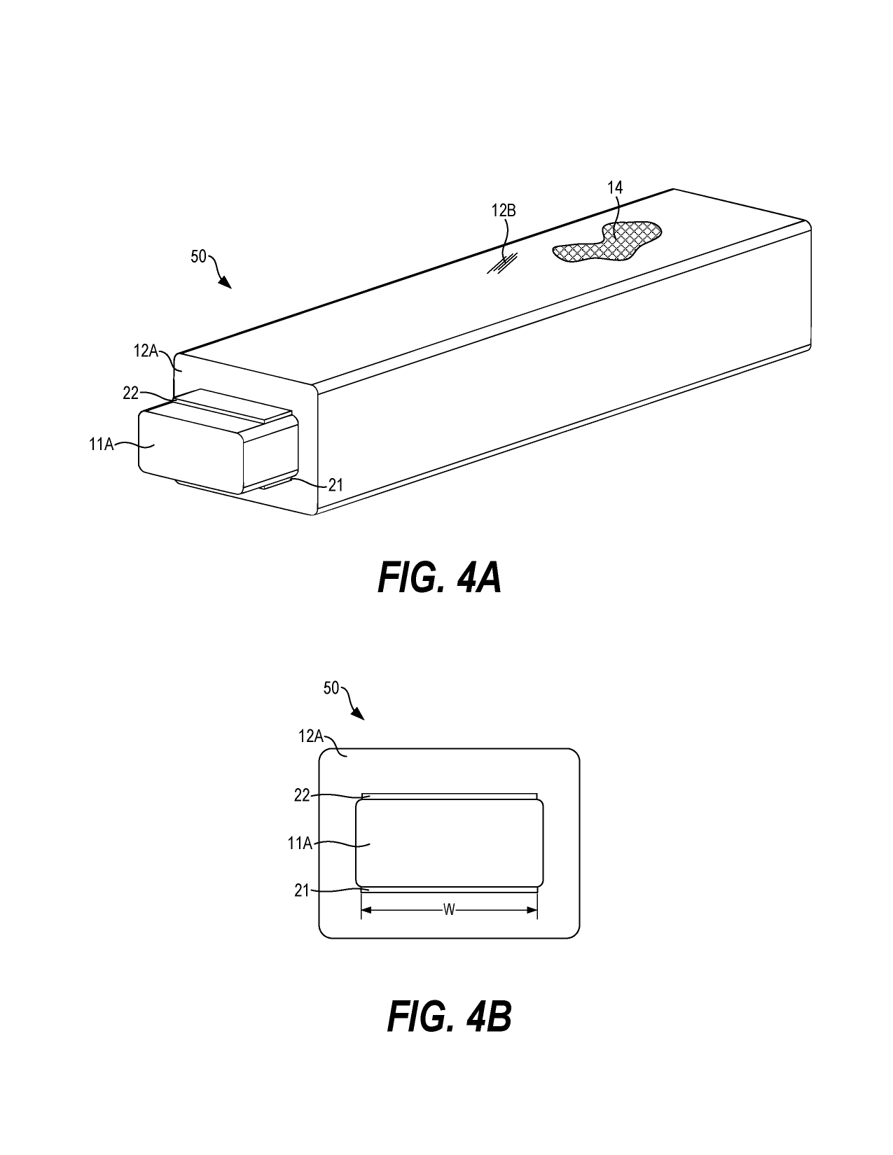

The first dielectric core 11 is formed and shaped as a rectangular cuboid and includes outer or exterior planar surfaces of a rectangular cuboid. The second dielectric core 12 is formed and shaped as a rectangular cuboid tube and includes outer and inner planar surfaces of a rectangular cuboid tube. The shapes of the dielectric cores 11 and 12 can vary as compared to that shown. For example, the first dielectric core 11 is depicted in FIGS. 1A-1C as a rectangular cuboid with right-angle corners and the second dielectric core 12 is depicted as a rectangular cuboid with curved outer corners. However, in other examples, the first dielectric core 11 can also include curved outer corners. In still other examples, the dielectric cores 11 and 12 can be formed to other shapes, including square, circular, oblong, oval, and other shapes. Examples of cables including dielectric cores having alternative shapes are shown in FIGS. 4A, 5, 7, and 7A and are described below.

The boundary structures 21 and 22 can be embodied as flat wires or conductors or, alternatively, as a dielectric insulating material. Thus, in some embodiments, the boundary structures 21 and 22 can be embodied as flat wires or conductors of metal, such as Copper conductors, Silver-plated Copper conductors, or conductors formed from other metal(s), with or without plating. The outer surfaces of the flat wires can be plated with one or more plating metal layers of Gold, Silver, Nickel, Tin, or other metal(s) in some cases. In other embodiments, the boundary structures 21 and 22 can be embodied as flat dielectric material structures. Each of the boundary structures 21 and 22 can be formed from a third dielectric material different than the materials from which the dielectric cores 11 and 12 are formed. The dielectric constant of the third dielectric material of the boundary structures 21 and 22, Dk₂₁, can be greater than both Dk₁₁of the first dielectric core 11 and Dk₁₂ of the second dielectric core 12. Dk₂₁ can be greater than 6, as one example, and other ranges and Dk values can be relied upon.

The size or dimensions of the boundary structures 21 and 22 can vary among the embodiments. The thicknesses of the boundary structures 21 and 22 can be measured between the inner and outer surfaces of the boundary structures 21 and 22, as described below. Generally, the thicknesses of the boundary structures 21 and 22 can be smaller than the diameters of conductors used in other cables, such as twisted pair or twinax cables. The thicknesses of the boundary structures 21 and 22 can be smaller than the diameters of 22-34 AWG conductors, for example. However, the boundary structures 21 and 22 are not limited to any particular dimensions, and the dimensions of the boundary structures 21 and 22 can be tailored based on the frequency of RF signals communicated through the cable 10, among other considerations.

The boundary structures 21 and 22 are positioned within the cable 10 as shown in FIGS. 1A-1C. More particularly, the boundary structures 21 and 22 are positioned and extend along an interface between the first dielectric core 11 and the second dielectric core 12. The first boundary structure 21 is positioned and extends along a first interface region between the first dielectric core 11 and the second dielectric core 12. The second boundary structure 22 is positioned and extends along a second interface region between the first dielectric core 11 and the second dielectric core 12. The boundary structures 21 and 22 have flat (i.e., planar) or substantially flat outer surfaces. As shown in FIG. 1C, the boundary structure 21 includes an inner surface 21A and an outer surface 21B, and both surfaces 21A and 21B are planar or substantially planar. The boundary structure 22 includes an inner surface 22A and an outer surface 22B, and both surfaces 22A and 22B are planar or substantially planar.

In the cable 10, the inner surface 21A of the boundary structure 21 faces the inner surface 22A of the boundary structure 22, with a distance “D” and the first dielectric core 11 between them. The distance “D” between the boundary structures 21 and 22 is the same or substantially the same along the entire length “L” of the cable 10, and the boundary structure 21 extends parallel to the boundary structure 22 along the length “L” of the cable 10. The distance “D” can range among the embodiments, such as between 1-5 mm, including example distances of 0.5 mm, 1.0 mm, 1.5 mm, 2.0 mm, 2.5 mm, 3.0 mm, 3.5 mm, 4.0 mm, 4.5 mm, and 5.0 mm, and smaller and larger distances can be relied upon. The width “W” of the boundary structure 21, the boundary structure 22, and the first dielectric core 11 are the same or substantially the same as each other in the example of the cable 10 shown in FIGS. 1A-1C. The width “W” can range among the embodiments, such as between 3-10 mm, including widths of 3 mm, 4 mm, 5 mm, 6 mm, 7 mm, 8 mm, 9 mm, and 10 mm, and smaller and larger widths can be relied upon.

The boundary structure 21 extends between or along an interface between the first dielectric core 11 and the second dielectric core 12. An inhomogeneity in dielectric constants exists at the boundary interface between the first dielectric core 11 and the second dielectric core 12. The boundary structure 21 is positioned and extends along a first region of the boundary interface between the first dielectric core 11 and the second dielectric core 12, where the dielectric constant inhomogeneity exists in the cable 10. The inner surface 21A of the boundary structure 21 faces and contacts the first dielectric core 11, and the outer surface 21B of the boundary structure 21 faces and contacts the second dielectric core 12.

The boundary structure 22 also extends between or along the interface between the first dielectric core 11 and the second dielectric core 12. The boundary structure 22 is positioned and extends along a second region of the boundary interface between the first dielectric core 11 and the second dielectric core 12, where the dielectric constant inhomogeneity exists in the cable 10. The inner surface 22A of the boundary structure 22 faces and contacts the first dielectric core 11, and the outer surface 22B of the boundary structure 22 faces and contacts the second dielectric core 12.

In some cases, the outer surface 12B or one or more regions of the outer surface 12B of the dielectric core 12 can be plated or metalized, and FIGS. 1A and 1B illustrate an example plating region 14 of the cable 10. The plating region 14 is shown as a representative example in FIGS. 1A and 1B. The size and shape of the plating region 14 can vary as compared to that depicted. The cable 10 can also include additional plating regions similar to the plating region 14. The plating region 14 can cover or encompass the entire outer surface 12B of the dielectric core 12 in some cases, or one or more regions less than the entire outer surface 12B in other cases. The cable 10 can also omit the plating region 14 and lack any plating on the outer surface 12B of the dielectric core 12. Rather than plating, a metal shield layer can be separately wrapped or otherwise placed around the dielectric core 12 of the cable 10, as described below.

To form the plating region 14, the outer surface 12B of the dielectric core 12 can be etched and plated in a bath, barrel plated, plated by chemical or physical vapor deposition (PVD), plated by electroless plating, electroplating, sputter plating, ion plating, spin coating, dip coating, epitaxial growth, or other plating techniques or a combination thereof. The outer surface 12B of the dielectric core 12 can be metalized or plated with Copper, Nickel, Tin, Silver, other plating metals, or combinations of plating metals. In another metallization approach, the material from which the dielectric core 12 is formed can include a laser direct structuring (LDS) additive. A laser beam can be used to activate the LDS additive over one or more regions of the outer surface 12B of the dielectric core 12 for metallization. A subsequent metallization process can be performed by submerging the dielectric core 12 in a bath, and conductive metal plating can adhere to the activated surfaces or surface areas of the dielectric core 12. A number of different metal plating layers can be successively plated by that approach.

FIG. 1A also illustrates the cable 10 in an example data interconnect application or system for data communication. In FIG. 1A, the cable 10 facilitates chip-to-chip data communication between two different chips on two different PCBs. FIG. 1A illustrates a first PCB 30A with a first processing chip 32A and a second PCB 30B with a second processing chip 32B. The first PCB 30A also includes a first RF antenna 34A, and the second PCB 30B also includes a second RF antenna 34B. The processing chips 32A and 32B can be embodied as a range of different processing chips, such as central processing units (CPUs), graphics processing units (GPUs), application specific integrated circuits (ASICs), and other processing chips and combinations of two or more thereof. The processing chips 32A and 32B can include physical layer communications circuitry, including circuitry for data modulation and demodulation using RF signals. A data input/output (I/O) of the first processing chip 32A is electrically coupled to the first RF antenna 34A, and a data I/O of the second processing chip 32B is electrically coupled to the second RF antenna 34B. The cable 10 is positioned and coupled between the RF antennas 34A and 34B for the communication of data on RF signals between the processing chips 32A and 32B on the PCBs 30A and 30B.

As shown in FIG. 1A, the first RF antenna 34A is positioned and embedded at a first distal end (i.e., at the left of the page in FIG. 1A) of the cable 10. The first RF antenna 34A is positioned and embedded centrally, or substantially centrally, within the first dielectric core 11 at the first distal end of the cable 10 in the example shown. RF signals can be transmitted and received over the data cable 10 by the first RF antenna 34A at the first distal end. RF signals transmitted by the first RF antenna 34A can couple to the inner surfaces 21A and 22A of the boundary structures 21 and 22 and be propagated on and along the boundary structures 21 and 22 of the cable 10, to the second distal end (i.e., at the right of the page in FIG. 1A) of the cable 10. The RF signals can propagate along the boundary structures 21 and 22 in TE or TM mode, for example, although the cable 10 is not intended to be limited to use with any particular transport mode. RF signals can propagate through the cable 10 in other ways, however, and the position of the first RF antenna 34A can vary as compared to that shown (e.g., be offset from center) in other applications.

The second RF antenna 34B is positioned and embedded centrally, or substantially centrally, within the first dielectric core 11 at the second distal end of the cable 10. RF signals can be transmitted and received over the data cable 10 by the second RF antenna 34B at the second distal end. RF signals transmitted by the second RF antenna 34B will couple to the inner surfaces 21A and 22A of the boundary structures 21 and 22 and be propagated on and along the boundary structures 21 and 22 of the cable 10, to the first distal end of the cable 10. RF signals can propagate through the cable 10 in other ways, however, and the position of the second RF antenna 34B can vary as compared to that shown in other applications. Overall, FIG. 1A depicts an example application of the cable 10 for data communication between the processing chips 32A and 32B on two different PCBs 30A and 30B. The cable 10 can be used in other ways, and additional cables similar to the cable 10 can be relied upon to extend the overall data bandwidth between the PCBs 30A and 30B, among others in a system for data communication. The other cables described herein, including the cables 40, 40A, 50, 60, 60A, 80A, and 80B described below, can also be used in place of the cable 10 in the system for data communication shown in FIG. 1A.

The design and structure of the cable 10 is different than other types of cables, such as twisted pair, twinax, coaxial, and other cables used for data interconnects. The transport mode of the cable 10 is also different than that used in twisted pair, twinax, coaxial, and other types of cables. The cable 10 can offer greater bandwidth, smaller size, lower cost, and other advantages as compared to other types of cables. The cable 10, and similar cables described herein, can also be ribboned or ribbonized together with additional cables using a flexible shield layer, combined with drain conductors, and combined together with other components. These and other aspects of the embodiments are described below.

The cable 10 can be manufactured or assembled in a number of different ways. As one example, a method of manufacturing the cable 10 can include drawing or extruding a first dielectric insulating material using a drawing tower or extrusion tool, to form the first dielectric core 11. The boundary structures 21 and 22 can be separately sourced or formed, and the method can include arranging the boundary structures 21 and 22 on opposite sides of the first dielectric core 11. The method can then include placing a second dielectric insulating material around the first dielectric core 11 and the boundary structures 21 and 22, to form a type of preform. The preform can then be placed into a drawing tower, an extrusion machine, or related tool, and then the method can include drawing or extruding the preform to arrive at the cable 10 shown in FIGS. 1A-1C. Heat can be applied, as needed, in the drawing or extruding steps. The second dielectric insulating material of the second dielectric core 12 can be selected to have a melting point that is lower than the melting point of the first dielectric insulating material of the first dielectric core 11, to ensure the structural integrity and arrangement of the first dielectric core 11 and boundary structures 21 and 22 during the final drawing or extruding steps.

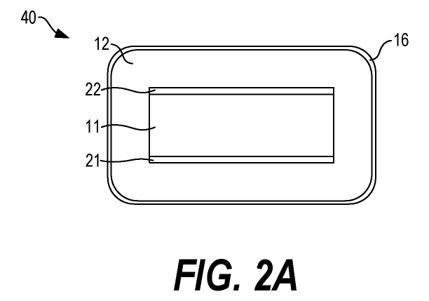

FIG. 2A illustrates an end view of another waveguide cable 40 (also “cable 40”) according to various embodiments of the present disclosure. The cable 40 is similar to the cable 10 shown in FIGS. 1A-1C but also includes a cover layer 16. The cover layer 16 extends around the second dielectric core 12, as shown. In one example, the cover layer 16 can be embodied as a shield layer of conductive metal, such as a foil or film layer of Aluminum, Copper, Tin, Nickel, or other metal(s). Such a shield layer can be relatively thin and flexible. The shield layer can be secured to the outer surface 12B of the dielectric core 12 using an adhesive or related attachment means in some cases. The shield layer can be relied upon to isolate RF signals carried over the cable 10 from crosstalk interference induced from other signals on other cables. In another example, the cover layer 16 can be embodied as an insulating layer of dielectric material. The dielectric material of the cover layer 16 can be different than either of the dielectric materials of the dielectric cores 11 and 12. The dielectric material of the cover layer 16 can have a dielectric constant Dk₁₆that is greater than both Dk₁₁ of the first dielectric core 11 and Dk₁₂ of the second dielectric core 12. Dk₁₆can be greater than6, as one example, and other ranges and Dk values can be relied upon.

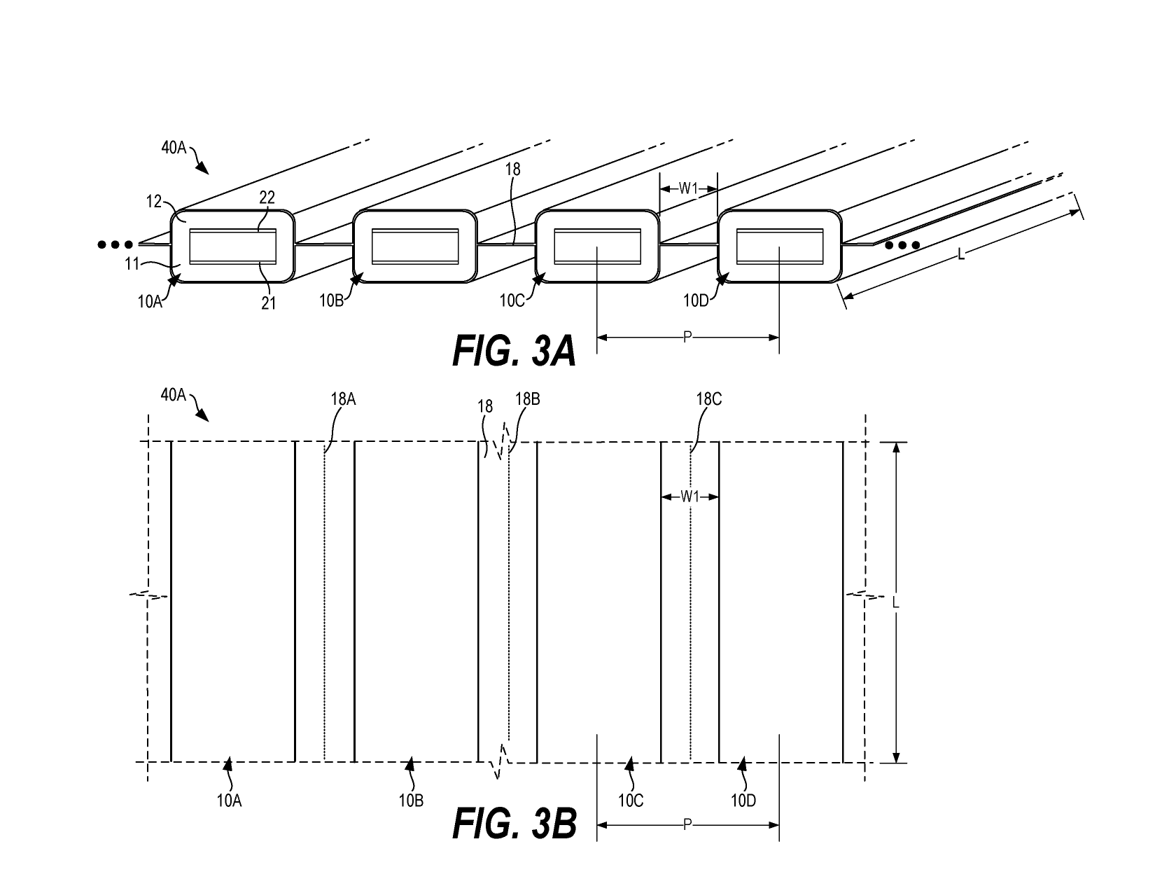

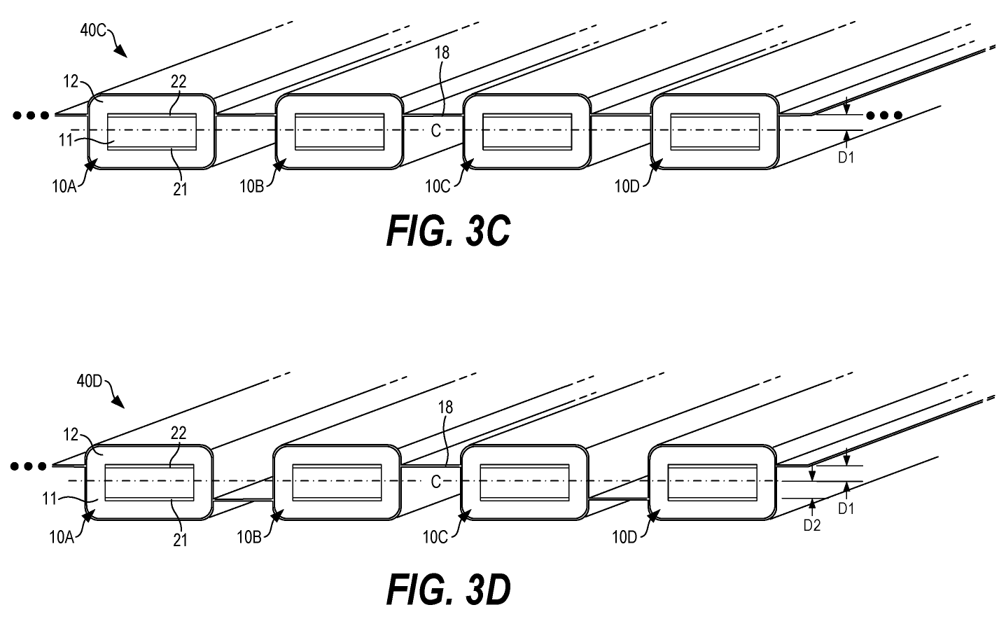

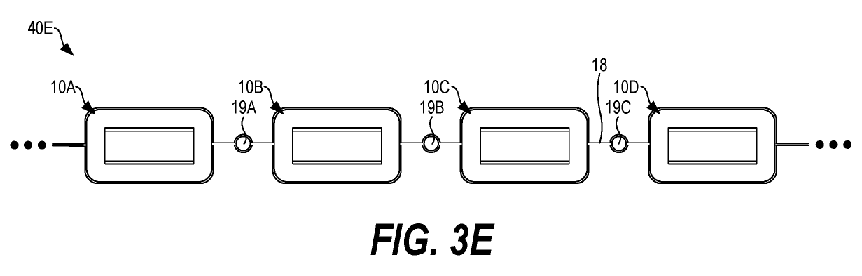

FIG. 3A illustrates an end view of a ribboned waveguide cable 40A (also “ribboned cable 40A”) according to various embodiments of the present disclosure. The ribboned cable 40A is illustrated as a representative example and is not drawn to any particular scale or size. The shape, size, proportion, and other characteristics of the ribboned cable 40A can vary as compared to that shown. For example, the number, size, and shape of the individual cables in the ribboned cable 40A and other characteristics of the ribboned cable 40A can vary as compared to that shown. The ribboned cable 40A can be formed to any suitable length (e.g., see example length “L” in FIGS. 1A and 3B). Additionally, in some cases, one or more parts or components of the ribboned cable 40A can be omitted. The ribboned cable 40A can also include other parts or components that are not illustrated in FIG. 3A.

The ribboned cable 40A includes a number of waveguide cables 10A-10D and a cover layer 18 that extends over, positions, and secures the waveguide cables 10A-10D. Four (4) waveguide cables 10A-10D, evenly spaced apart from each other at a distance or pitch “P”, are shown in FIG. 3A. The ribboned cable 40A can include any suitable number of waveguide cables, however, such as four, five, six, seven, eight, nine, ten, eleven, twelve, or more waveguide cables. Each of the cables 10A-10D can be the same as or similar to the cable 10 shown in FIGS. 1A-1C. The cable 10A, for example, can include the first dielectric core 11, second dielectric core 12, first boundary structure 21, and second boundary structure 22, and the cables 10B-10D can include the same or similar components. The cables 10A-10D are arranged and secured together in a ribboned or ribbonized format by the cover layer 18. The cover layer 18 can be similar to, but larger than, the cover layer 16 described above. The cover layer 18 can be relatively thin and flexible, permitting the ribboned waveguide cable 40A to bend and flex to some extent. Each of the cables 10A-10D in the ribboned cable 40A can be the same as or similar to the cable 10 shown in FIGS. 1A-1C. In other cases, each of the cables 10A-10D in the ribboned cable 40A can be embodied as the cables 50, 60, or 60A described below, and the ribboned cable 40A can also include combinations of the cables 10, 50, 60, and 60A.

The distance or pitch “P” between the waveguide cables 10A-10D can be tailored to maintain crosstalk among the waveguide cables 10A-10D to a level lower than application and system requirements, and the pitch “P” can also be selected based on other factors. The cover layer 18 extends a width “W1” between the waveguide cables 10A-10D, and the width “W1” can be determined in connection with the pitch “P” among the waveguide cables 10A-10D. The cover layer 18 is securely seamed together over the regions having width “W1” between the waveguide cables 10A-10D, preferably without any openings between the layers of the cover layer 18, as described below. The pitch “P” and width “W1” is the same between each pair of the waveguide cables 10A-10D in the example shown in FIG. 3A. In other examples, the pitch “P” and width “W1” can be different between two or more of the waveguide cables 10A-10D.

The cover layer 18 can be embodied as a shield layer including two separate sheets or layers of conductive metal (e.g., top and bottom metal layers). The cables 10A-10D can be arranged and “sandwiched” between the metal layers, with an adhesive applied between the metal layers of the shield layer. The layers of the shield layer and the cables 10A-10D can then be passed through a roller or rollers to press and secure the layers of the shield layer together with the adhesive, to hold the cables 10A-10D in place. The shield layer can isolate the RF signals carried over the cables 10A-10D from each other, to reduce or eliminate crosstalk interference among the cables 10A-10D. In another example, the shield layer can be embodied as a single metal layer, and the shield layer can be applied and wrapped around (e.g., cigarette wrapped) the cables 10A-10D, with an adhesive applied between top and bottom layers of the shield layer. The single metal layer of the shield layer and the cables 10A-10D can be passed through a roller or rollers to press and secure the top and bottom layers of the shield layer together with the adhesive, to hold the cables 10A-10D in place between the top and bottom layers. In either case, the cover layer 18 can be applied to fully and entirely surround and seal the cables 10A-10D within the cover layer 18, without (or with minimal) openings or air pockets between the cover layer and the cables 10A-10D. The shield layer can be separately terminated (i.e., electrically coupled to ground) at both distal ends of the ribboned cable 40A in some cases.

In another example, the cover layer 18 can be embodied as one or more insulating sheets or layers of dielectric material. The dielectric material of the cover layer 18 can be different than either of the dielectric materials of the dielectric cores 11 and 12. The dielectric material of the cover layer 18 can have a dielectric constant Dk₁₈ that is greater than both Dk₁₁ of the first dielectric core 11 and Dk₁₂ of the second dielectric core 12. Dk₁₈ can be greater than 6, as one example, and other ranges and Dk values can be relied upon.

The cover layer 18 can be embodied two separate insulating sheets or layers of dielectric material, and the cables 10A-10D can be arranged and “sandwiched” between the insulating layers, with an adhesive applied between the insulating layers. The insulating layers of the cover layer 18 and the cables 10A-10D can then be passed through a roller or rollers to press and secure the insulating layers of the cover layer 18 together with the adhesive, to hold the cables 10A-10D in place. In another example, the cover layer 18 can be embodied as a single insulating layer, and the insulating layer can be applied and wrapped around (e.g., cigarette wrapped) the cables 10A-10D, with an adhesive applied between top and bottom layers of the insulating layer. The single insulating layer and the cables 10A-10D can then be passed through a roller or rollers to press and secure the top and bottom insulating layers together with the adhesive, to hold the cables 10A-10D in place between the top and bottom insulating layers. In either case, the cover layer 18 can be applied to fully and entirely surround and seal the cables 10A-10D within the cover layer 18, without (or with minimal) openings or air pockets between the cover layer and the cables 10A-10D. As described above, the cover layer 18 is not applied as a helical wrap applied helically along the length “L” (e.g., see example length “L” in FIG. 1A) of a cable, which can leave small indentations at the edges of the wrap.

FIG. 3B illustrates a top view of the ribboned cable 40A shown in FIG. 3A. The waveguide cables 10A-10D are shown in FIG. 3B, separate from each other at the pitch “P”, along with the cover layer 18. The cover layer 18 extends over and between the waveguide cables 10A-10D and secures the waveguide cables 10A-10D together in the ribboned or ribbonized format. FIG. 3B also illustrates perforation lines 18A-18C. The perforation lines 18A-18C can be embodied as lines of perforations, formed as scores, cuts, small openings, or other perforations formed in the cover layer 18 between the waveguide cables 10A-10D. The perforation lines 18A-18C are illustrated to extend the length “L” of the ribboned cable 40A in the example shown, but the perforation lines 18A-18C can extend for shorter distances. The perforation lines 18A-18C are also illustrated to extend in straight, centered lines between the waveguide cables 10A-10D, but the perforation lines 18A-18C can be offset from center and extend in curved, angled, zigzag, or other patterns or shapes in other cases.

FIG. 3C illustrates an end perspective view of another ribboned waveguide cable 40C (also “ribboned cable 40C”) according to various embodiments of the present disclosure. The ribboned cable 40C is illustrated as a representative example and is not drawn to any particular scale or size. The shape, size, proportion, and other characteristics of the ribboned cable 40C can vary as compared to that shown. For example, the number, size, and shape of the individual cables in the ribboned cable 40C and other characteristics of the ribboned cable 40C can vary as compared to that shown. The ribboned cable 40C can be formed to any suitable length (e.g., see example length “L” in FIGS. 1A and 3B). Additionally, in some cases, one or more parts or components of the ribboned cable 40C can be omitted. The ribboned cable 40C can also include other parts or components that are not illustrated in FIG. 3C, such as the perforation lines described in FIG. 3B.

The ribboned cable 40C includes the waveguide cables 10A-10D, among possibly others, and the cover layer 18 that extends over, positions, and secures the waveguide cables 10A-10D. The cables 10A-10D are arranged and secured together in a ribboned or ribbonized format by the cover layer 18 in the ribboned cable 40C. However, in FIG. 3C, the cover layer 18 is arranged over and around the waveguide cables 10A-10D in a different way than in the ribboned cable 40A shown in FIG. 3A. A centerline “C” is drawn through the waveguide cables 10A-10D in FIG. 3C. The centerline “C” extends centrally between the first boundary structure 21 and the second boundary structure 22 of the waveguide cable 10A, and it extends centrally between the other waveguide cables 10B-10D in a similar way. The cover layer 18 is arranged over the waveguide cables 10A-10D such that it extends between the waveguide cables 10A-10D at an offset “D1” from the centerline “C”. The seamed regions of the cover layer 18 between the waveguide cables 10A-10D do not coincide with the centerline “C,” which is different than the ribboned cable 40A shown in FIG. 3A. Offsetting the seams of the cover layer 18 apart from the centerline “C” can reduce any impact on signal propagation through the waveguide cables 10A-10D that may be caused by the cover layer 18. The seams of the cover layer 18 are offset from center the centerline “C” by the offset “D1” in the ribboned cable 40C. Thus, any impact on signal propagation that may be caused by the cover layer 18 can be offset or removed from the centerline “C” of the ribboned cable 40C, where a more significant part of signal energy travels down the waveguide cables 10A-10D. The extent or size of the offset “D1” can vary among the embodiments. In the example shown, the offset “D1” is selected so that the seams of the cover layer 18 are aligned with the second boundary structure 22, and other offsets are within the scope of the embodiments. The seams of the cover layer 18 can alternatively be aligned with the first boundary structure 21, and other seam offsets can also be relied upon.

FIG. 3D illustrates an end perspective view of another ribboned waveguide cable 40D (also “ribboned cable 40D”) according to various embodiments of the present disclosure. The ribboned cable 40D is illustrated as a representative example and is not drawn to any particular scale or size. The shape, size, proportion, and other characteristics of the ribboned cable 40D can vary as compared to that shown. For example, the number, size, and shape of the individual cables in the ribboned cable 40D and other characteristics of the ribboned cable 40D can vary as compared to that shown. The ribboned cable 40D can be formed to any suitable length (e.g., see example length “L” in FIGS. 1A and 3B). Additionally, in some cases, one or more parts or components of the ribboned cable 40D can be omitted. The ribboned cable 40D can also include other parts or components that are not illustrated in FIG. 3D, such as the perforation lines described in FIG. 3B.

The ribboned cable 40D includes the waveguide cables 10A-10D, among possibly others, and the cover layer 18 that extends over, positions, and secures the waveguide cables 10A-10D. The cables 10A-10D are arranged and secured together in a ribboned or ribbonized format by the cover layer 18 in the ribboned cable 40D. However, in FIG. 3D, the cover layer 18 is arranged over and around the waveguide cables 10A-10D in a different way than in the ribboned cable 40A shown in FIG. 3A or the ribboned cable 40C shown in FIG. 3C. The cover layer 18 is arranged over the waveguide cables 10A-10D such that it extends between the waveguide cables 10A-10D at two different offsets “D1” and “D2” from the centerline “C”. The ribboned cable 40D includes two different seam offsets (e.g., upper and lower seam offsets), alternating between the offsets “D1” and “D2”, among the waveguide cables 10A-10D. The size of the offsets “D1” and “D2” can vary among the embodiments. In the example shown, the offset “D1” is selected so that upper seams of the cover layer 18 are aligned with the second boundary structure 22, and the offset “D2” is selected so that lower the seams of the cover layer 18 are aligned with the second boundary structure 22. Other offsets are within the scope of the embodiments. Offsetting the seams of the cover layer 18 apart from the centerline “C” can reduce any impact on signal propagation through the waveguide cables 10A-10D that may be caused by the cover layer 18.

In the ribboned cable 40D, the cover layer 18 includes a lower seam between the waveguide cables 10A and 10B, an upper seam between the waveguide cables 10B and 10C, and a lower seam between the waveguide cables 10C and 10D, and the seams can continue to alternate between upper and lower seams across the ribboned cable 40D. Other alterations of upper and lower seams are also within the scope of the embodiments, such as two, three, or more upper seams followed by two, three, or more lower seams. Two, three, or more upper seams can also be followed by a single lower seam, and other variations can be relied upon in other cases.

FIG. 3E illustrates an end view of another ribboned waveguide cable 40E (also “ribboned cable 40E”) according to various embodiments of the present disclosure. The ribboned cable 40E is illustrated as a representative example and is not drawn to any particular scale or size. The shape, size, proportion, and other characteristics of the ribboned cable 40B can vary as compared to that shown. For example, the number, size, and shape of the individual cables in the ribboned cable 40E and other characteristics of the ribboned cable 40E can vary as compared to that shown. The ribboned cable 40E can be formed to any suitable length (e.g., see example length “L” in FIG. 1A). Additionally, in some cases, one or more parts or components of the ribboned cable 40E can be omitted. The ribboned cable 40E can also include other parts or components that are not illustrated in FIG. 3E.

The ribboned cable 40E includes the waveguide cables 10A-10D, the cover layer 18, and drain conductors 19A-19C. The ribboned cable 40E shown in FIG. 3B is similar to the ribboned cable 40A shown in FIG. 3A, but the ribboned cable 40E also includes the drain conductors 19A-19C. The drain conductors 19A-19C can be embodied as Copper conductors, Silver-plated Copper conductors, or conductors formed from other metal(s), with or without plating. Each of the drain conductors 19A-19C is positioned centrally between two of the waveguide cables 10A-10D, between layers of the cover layer 18. Three (3) drain conductors 19A-19C are shown in FIG. 3E. The ribboned cable 40B can include any suitable number of drain conductors, however, such as four, five, six, seven, eight, nine, ten, eleven, twelve, or more drain conductors. The drain conductors 19A-19C are arranged and secured together in a ribboned or ribbonized format, between the waveguide cables 10A-10D, by the cover layer 18. The drain conductors 19A-19C can cooperate with the cover layer 18, particularly when the cover layer 18 is embodied as a shield layer of conductive metal, to isolate the RF signals carried over the cables 10A-10D from each other and reduce or eliminate crosstalk interference among the cables 10A-10D. When the cover layer 18 is embodied as a shield layer of conductive metal, the conductive metal of the cover layer 18 can be electrically coupled and bonded to the drain conductors 19A-19C. The drain conductors 19A-19C can also be separately terminated (i.e., electrically coupled to ground) at both distal ends of the ribboned cable 40E.

Each of the cables 10A-10D in the ribboned cable 40E can be the same as or similar to the cable 10 shown in FIGS. 1A-1C. In other cases, each of the cables 10A-10D in the ribboned cable 40B can be embodied as the cables 50, 60, or 60A described below, and the ribboned cable 40E can also include combinations of the cables 10, 50, 60, and 60A. The ribboned cable 40E can also include the perforation lines described above with reference to FIG. 3B and incorporate offset seams, such as the upper and lower offset seams described above with reference to FIGS. 3C and 3D.

Turning to another example, FIG. 4A illustrates a perspective view of another example waveguide cable 50 (also “cable 50”), and FIG. 4B illustrates an end view of the cable 50. The cable 50 is provided as an example of an electrical interconnect capable of transmitting data signals. The cable 50 is particularly designed for the propagation of data carried on (e.g., modulated on) RF signals at relatively high frequencies, including microwave frequencies, but the cable 50 is not limited to use with any particular type of signal(s). The cable 50 is illustrated as a representative example and is not drawn to any particular scale or size. The shape, size, proportion, and other characteristics of the cable 50 can vary as compared to that shown. The cable 50 can also be formed to any suitable length “L” (e.g., see example length “L” in FIG. 1A). Additionally, in some cases, one or more parts or components of the cable 50 can be omitted. The cable 50 can also include other parts or components that are not illustrated in FIGS. 4A and 4B, such as a shield layer, an outer insulating jacket, and/or possibly or other components in some cases.

The cable 50 is similar to the cable 10 shown in FIGS. 1A-1C and includes a first dielectric core 11A, a second dielectric core 12A, and a pair of boundary structures. The pair of boundary structures includes the first boundary structure 21 and the second boundary structure 22. The boundary structure 21 extends along a first interface region between the first dielectric core 11A and the second dielectric core 12A. The boundary structure 22 extends along a second interface region between the first dielectric core 11A and the second dielectric core 12A. The second dielectric core 12A extends around the boundary structures 21 and 22 and around the first dielectric core 11A.

The dielectric cores 11A and 12A in the cable 50 are similar to the dielectric cores 11 and 12 in the cable 10 shown in FIGS. 1A-1C. The dielectric core 11A can be formed from the same dielectric material as the dielectric core 11, and the dielectric core 12A can be formed from the same dielectric material as the dielectric core 12. However, the dielectric cores 11A and 12A have a different shape than the dielectric cores 11 and 12. The dielectric core 11A is formed as a rectangular cuboid with curved outer corners, rather than sharp angle outer corners, as compared to the dielectric core 11. The second dielectric core 12A is formed and shaped as a rectangular cuboid tube, but the inner tube of the second dielectric core 12A has curved corners to conform with the shape of the dielectric core 11A.

The width “W” of the boundary structure 21 can be the same or substantially the same as the boundary structure 22 in the cable 50. The boundary structures 21 and 22 are not as wide as the full width of the dielectric core 11A. In other words, the width “W” of the boundary structures 21 and 22 is less than the width of the dielectric core 11A in the cable 50. Curved corners of the dielectric cores 11A and 12A can be expected in some cases using certain extrusion process steps. At the same time, it can be desirable for the boundary structures 21 and 22 to run along only the inhomogeneity in dielectric constants at the boundary interface between the dielectric cores 11A and 12A. Thus, in the cable 50, the boundary structure 21 extends only along a first interface region between the dielectric cores 11A and 12A where interface is planar or flat and not curved. In a similar way, the boundary structure 22 extends only along a second interface region between the dielectric cores 11A and 12A where interface is planar or flat and not curved. Thus, the widths “W” of the boundary structures 21 and 22 can be tailored to run along only planar or flat interface regions between the dielectric cores 11A and 12A.

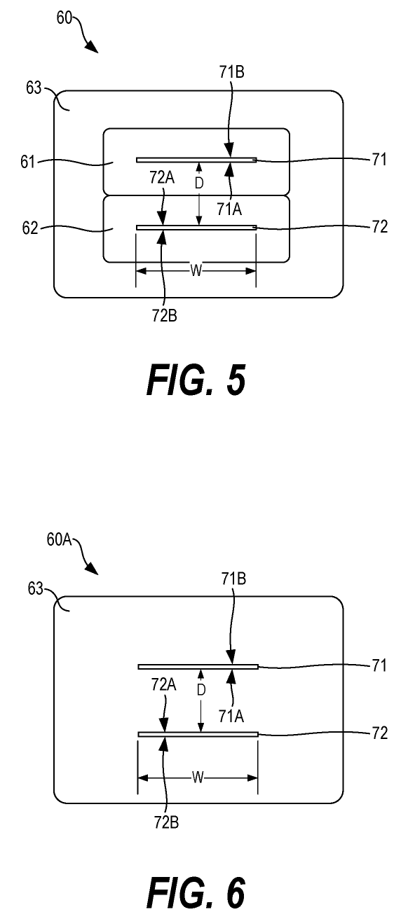

Turning to another example, FIG. 5 illustrates an end view of another waveguide cable 60 (also “cable 60”) according to various embodiments of the present disclosure. The cable 60 is provided as an example of an electrical interconnect capable of transmitting data signals. The cable 60 is particularly designed for the propagation of data carried on (e.g., modulated on) RF signals at relatively high frequencies, including microwave frequencies, but the cable 60 is not limited to use with any particular type of signal(s). The cable 60 is illustrated as a representative example and is not drawn to any particular scale or size. The shape, size, proportion, and other characteristics of the cable 60 can vary as compared to that shown. For example, the thicknesses of the boundary structures, the relative sizes or thicknesses of the dielectric cores, and other characteristics of the cable 60 can vary as compared to that shown. The cable 60 can also be formed to any suitable length “L” (e.g., see example length “L” in FIG. 1A). Additionally, in some cases, one or more parts or components of the cable 60 can be omitted. The cable 60 can also include other parts or components that are not illustrated in FIG. 5, such as a shield layer, an outer insulating jacket, and/or possibly or other components in some cases.

The cable 60 includes a first dielectric core 61, a second dielectric core 62, a first boundary structure 71 positioned within the first dielectric core 61, a second boundary structure 72 positioned within the second dielectric core 62, and a third dielectric core 63. The third dielectric core 63 extends around the first and second dielectric cores 61 and 62. Stated differently, along the length of the cable 60, the third dielectric core 63 extends entirely around the first and second dielectric cores 61 and 62. The first and second dielectric cores 61 and 62 are separate components in the example of the cable 60 shown in FIG. 5. However, in other examples, the first and second dielectric cores 61 and 62 can be formed as a single dielectric core, without being separated or formed separately, and the boundary structures 71 and 72 can be positioned with the single dielectric core.

The first and second dielectric cores 61 and 62 can be formed from the same first dielectric insulating material. As examples, the first and second dielectric cores 61 and 62 can be embodied as solid polyolefin, low-density polyolefin, polypropylene, PE, PE foam, PTFE, fluoropolymer, or other dielectric insulating material. Example Dk values of the first and second dielectric cores 61 and 62 can range from 1.5-6, and dielectric insulating materials having other Dk values can be relied upon.

The third dielectric core 63 can be embodied as a second dielectric insulating material. As examples, the third dielectric core 63 can be embodied as a solid or low-density polyolefin, polypropylene, PE, PE foam, PTFE, fluoropolymer, or other dielectric insulating material. Example dielectric constants of the third dielectric core 63 can range from 1.5-6 or more, and dielectric insulating materials having other Dk values can be relied upon. In some cases, the melting point of the third dielectric core 63 can be lower than the melting point of the first and second dielectric cores 61 and 62, for manufacturing or other purposes, as described in further detail below. In some cases, the outer surface or surface regions of the dielectric core 63 can be plated or metalized, similar to the plating region 14 described above with reference to FIGS. 1A and 1B.

In at least one preferred embodiment, the first dielectric insulating material of the first and second dielectric cores 61 and 62 is a different material than the second dielectric insulating material of the third dielectric core 63. The dielectric constant of the first and second dielectric cores 61 and 62, Dk₆₁, is also different than the dielectric constant of the third dielectric core 63, Dk₆₃, in that case. Dk₆₁ of the dielectric cores 61 and 62 can be greater than Dk₆₃ of dielectric core 63. As examples, Dk₆₁ can have a value between 3.5-6 and Dk₆₃ can have a value between 1.5-3, and other Dk values are within the scope of the embodiments. In other examples, Dk₆₁can be greater than 1.5 times (i.e., 1.5x ) Dk₆₃, greater than 2x, greater than 3x, or more.

However, in other cases, Dk₆₁ of the of the first and second dielectric cores 61 and 62 can be less than Dk₆₃ of the third dielectric core 63. As examples, Dk₆₁ can have a value between 1.5-3 and Dk₆₃ can have a value between 3.5-6, and other Dk values are within the scope of the embodiments. Dk₆₃ can be greater than 1.5 times (i.e., 1.5x ) Dk₆₁, greater than 2x, greater than 3x, or more. In still other cases, the first dielectric insulating material of the first and second dielectric cores 61 and 62 can be the same material as the second dielectric insulating material of the third dielectric core 63, and Dk₆₁ can be the same as Dk₆₃.

The boundary structures 71 and 72 can be embodied as flat wires or conductors or, alternatively, as a dielectric insulating material. Thus, in some embodiments, the boundary structures 71 and 72 can be embodied as flat wires or conductors of metal, such as Copper conductors, Silver-plated Copper conductors, or conductors formed from other metal(s), with or without plating. The outer surfaces of the flat wires can be plated with one or more plating metal layers of Gold, Silver, Nickel, Tin, or other metal(s) in some cases. In other embodiments, the boundary structures 71 and 72 can be embodied as flat dielectric material structures. Each of the boundary structures 71 and 72 can be formed from a third dielectric material different than the materials from which the dielectric cores 61-63 are formed. The dielectric constant of the third dielectric material of the boundary structures 71 and 72, Dk₇₁, can be greater than both Dk₆₁ of the dielectric cores 61 and 62 and Dk₆₃ of the dielectric core 63. Dk₇₁ can be greater than 6, as one example, and other ranges and Dk values can be relied upon.

The boundary structures 71 and 72 are positioned within the cable 60 as shown in FIG. 5. More particularly, the boundary structures 71 and 72 are positioned and extend within the dielectric cores 61 and 62, respectively. The boundary structures 71 and 72 have flat (i.e., planar) or substantially flat outer surfaces. As shown in FIG. 5, the boundary structure 71 includes an inner surface 71A and an outer surface 71B, and both surfaces 71A and 71B are planar or substantially planar. The boundary structure 72 includes an inner surface 72A and an outer surface 72B, and both surfaces 72A and 72B are planar or substantially planar.

In the cable 60, the inner surface 71A of the boundary structure 71 faces the inner surface 72A of the boundary structure 72, with a distance “D” between them. The distance “D” between the boundary structures 71 and 72 is the same or substantially the same along the entire length “L” of the cable 60, and the boundary structure 71 extends parallel to the boundary structure 72 along the length “L” of the cable 60. The distance “D” can range among the embodiments, such as between 1-5 mm, including example distances of 0.5 mm, 1.0 mm, 1.5 mm, 2.0 mm, 2.5 mm, 3.0 mm, 3.5 mm, 4.0 mm, 4.5 mm, and 5.0 mm, and smaller and larger distances can be relied upon. The width “W” of the boundary structure 71 and the boundary structure 72 are the same or substantially the same as each other. The width “W” can range among the embodiments, such as between 3-10 mm, including widths of 3 mm, 4 mm, 5 mm, 6 mm, 7 mm, 8 mm, 9 mm, and 10 mm, and smaller and larger widths can be relied upon.

The cable 60 can also be ribboned or ribbonized according to aspects of the embodiments. Thus, as one example, each of the cables 10A-10D of the ribboned cable 40A in FIG. 3A can be embodied as the cable 60. As another example, each of the cables 10A-10D of the ribboned cable 40B in FIG. 3B can be embodied as the cable 60.

FIG. 6 illustrates an end view of another waveguide cable 60A (also “cable 60A”) according to various embodiments of the present disclosure. The cable 60A is provided as an example of an electrical interconnect capable of transmitting data signals. The cable 60A is particularly designed for the propagation of data carried on (e.g., modulated on) RF signals at relatively high frequencies, including microwave frequencies, but the cable 60A is not limited to use with any particular type of signal(s). The shape, size, proportion, and other characteristics of the cable 60A can vary as compared to that shown. The cable 60A can also be formed to any suitable length “L” (e.g., see example length “L” in FIG. 1A). The cable 60A can include other parts or components that are not illustrated in FIG. 6, such as a plating layer, a shield layer, an outer insulating jacket, and/or possibly or other components in some cases.

The cable 60A in FIG. 6 is similar to the cable 60 in FIG. 5, but the cable 60A omits the first dielectric core 61 and the second dielectric core 62. The cable 60A includes the dielectric core 63, the first boundary structure 71 positioned within the dielectric core 63, and the second boundary structure 72 positioned within the dielectric core 63. The dielectric core 63 can be embodied as a dielectric insulating material. As examples, the dielectric core 63 can be embodied as a solid or low-density polyolefin, polypropylene, PE, PE foam, PTFE, fluoropolymer, or other dielectric insulating material. Example dielectric constants of the dielectric core 63 can range from 1.5-6 or more, and dielectric insulating materials having other Dk values can be relied upon.

The boundary structures 71 and 72 can be embodied as flat wires or conductors or, alternatively, as a dielectric insulating material. Thus, in some embodiments, the boundary structures 71 and 72 can be embodied as flat wires or conductors of metal, such as Copper conductors, Silver-plated Copper conductors, or conductors formed from other metal(s), with or without plating. The outer surfaces of the flat wires can be plated with one or more plating metal layers of Gold, Silver, Nickel, Tin, or other metal(s) in some cases. In other embodiments, the boundary structures 71 and 72 can be embodied as flat dielectric material structures. Each of the boundary structures 71 and 72 can be formed from a dielectric material different than the material from which the dielectric core 63 is formed. The dielectric constant of the boundary structures 71 and 72, Dk₇₁, can be greater than Dk₆₃ of the dielectric core 63. Dk₇₁ can be greater than 6, as one example, and other ranges and Dk values can be relied upon.

The boundary structures 71 and 72 are positioned within the cable 60A as shown in FIG. 6. More particularly, the boundary structures 71 and 72 are positioned and extend within the dielectric core 63. The boundary structures 71 and 72 have flat (i.e., planar) or substantially flat outer surfaces. As shown in FIG. 6, the boundary structure 71 includes an inner surface 71A and an outer surface 71B, and both surfaces 71A and 71B are planar or substantially planar. The boundary structure 72 includes an inner surface 72A and an outer surface 72B, and both surfaces 72A and 72B are planar or substantially planar.

In the cable 60A, the inner surface 71A of the boundary structure 71 faces the inner surface 72A of the boundary structure 72, with a distance “D” between them. The distance “D” between the boundary structures 71 and 72 is the same or substantially the same along the entire length “L” of the cable 60A, and the boundary structure 71 extends parallel to the boundary structure 72 along the length “L” of the cable 60A. The distance “D” can range among the embodiments, such as between 1-5 mm, including example distances of 0.5 mm, 1.0 mm, 1.5 mm, 2.0 mm, 2.5 mm, 3.0 mm, 3.5 mm, 4.0 mm, 4.5 mm, and 5.0 mm, and smaller and larger distances can be relied upon. The width “W” of the boundary structure 71 and the boundary structure 72 are the same or substantially the same as each other. The width “W” can range among the embodiments, such as between 3-10 mm, including widths of 3 mm, 4 mm, 5 mm, 6 mm, 7 mm, 8 mm, 9 mm, and 10 mm, and smaller and larger widths can be relied upon.

The cable 60A can also be ribboned or ribbonized according to aspects of the embodiments. Thus, as one example, each of the cables 10A-10D of the ribboned cable 40A in FIG. 3A can be embodied as the cable 60A. As another example, each of the cables 10A-10D of the ribboned cable 40B in FIG. 3B can be embodied as the cable 60A.

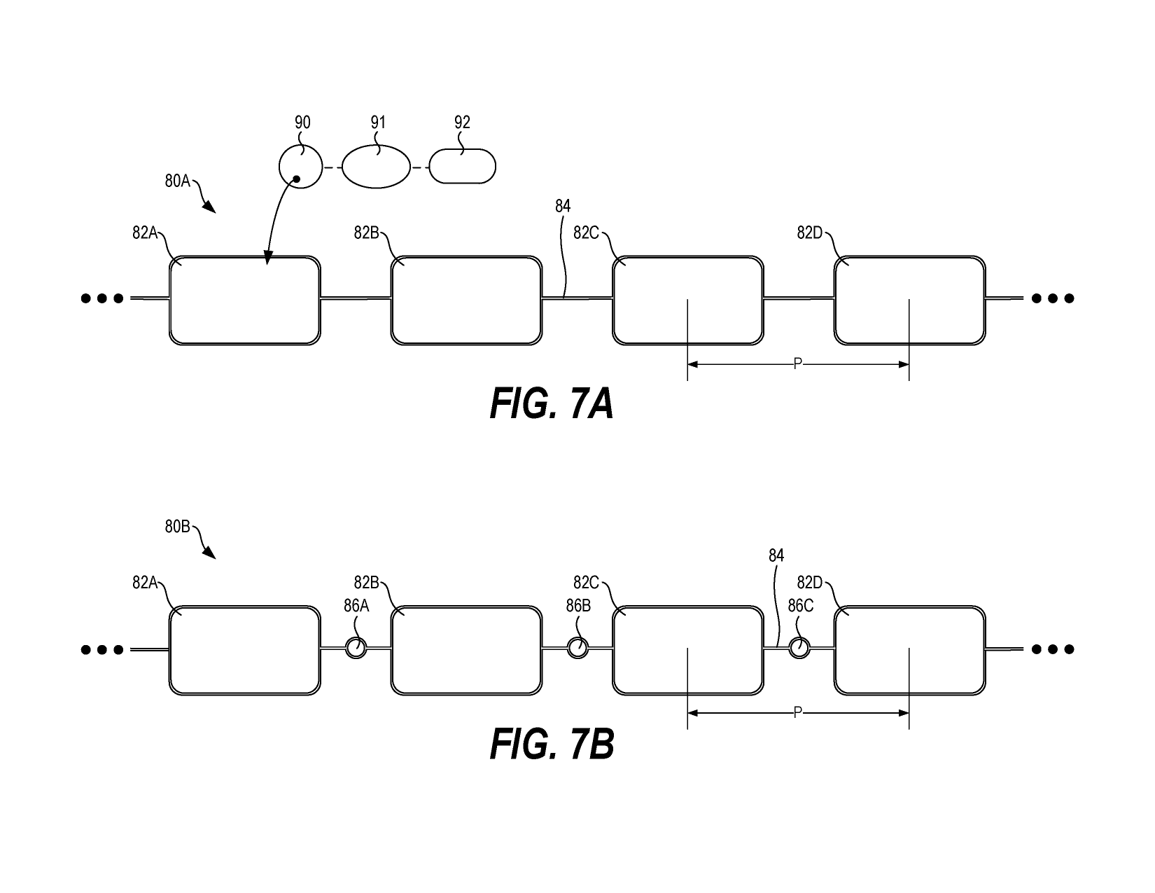

Turning to other examples, FIG. 7A illustrates an end view of a ribboned waveguide cable 80A (also “ribboned cable 80A”) according to various embodiments of the present disclosure. The ribboned cable 80A is illustrated as a representative example and is not drawn to any particular scale or size. The shape, size, proportion, and other characteristics of the ribboned cable 80A can vary as compared to that shown. For example, the number, size, and shape of the guide inserts in the ribboned cable 80A and other characteristics of the ribboned cable 80A can vary as compared to that shown. The ribboned cable 80A can be formed to any suitable length (e.g., see example length “L” in FIG. 1A). Additionally, in some cases, one or more parts or components of the ribboned cable 80A can be omitted. The ribboned cable 70A can also include other parts or components that are not illustrated in FIG. 7A.

The ribboned cable 80A includes a number of dielectric guide inserts 82A-82D (also “guide inserts 82A-82D”) and a cover layer 84 that extends over, positions, and secures the guide inserts 82A-82D. Four (4) guide inserts 82A-82D, evenly spaced apart from each other at a distance or pitch “P,” are shown in FIG. 7A. The ribboned cable 80A can include any suitable number of guide inserts, however, such as four, five, six, seven, eight, nine, ten, eleven, twelve, or more guide inserts. The guide inserts are arranged and secured together in a ribboned or ribbonized format by the cover layer 84.

Each of the guide inserts 82A-82D can be embodied as solid polyolefin, low-density polyolefin, polypropylene, PE, PE foam, PTFE, fluoropolymer, or other dielectric insulating material. More generally, the guide inserts 82A-82D can be embodied as an electrical insulator that polarizes in the presence of an electric field. Example dielectric constants (Dk) of the guide inserts 82A-82D can range from 1.5-6, and dielectric insulating materials having other Dk values can be relied upon for the guide inserts 82A-82D.

In one example, the cover layer 84 can be embodied as a shield layer including two separate layers of conductive metal (e.g., top and bottom metal layers), and the guide inserts 82A-82D can be arranged and “sandwiched” between the metal layers, with an adhesive applied between the metal layers of the shield layer. The layers of the shield layer and the guide inserts 82A-82D can then be passed through a roller or rollers to press and secure the layers of the shield layer together with the adhesive, to hold the guide inserts 82A-82D in place. In another example, the shield layer can be embodied as a single metal layer, and the shield layer can be applied and wrapped around (e.g., cigarette wrapped) the guide inserts 82A-82D, with an adhesive applied between top and bottom layers of the shield layer.

In another example, the cover layer 84 can be embodied as one or more insulating layers of dielectric material. The dielectric material of the cover layer 84 can be different than the dielectric material of the guide inserts 82A-82D. The dielectric material of the cover layer 84 can have a dielectric constant Dk₈₄ that is greater than the Dk₈₂ of the guide inserts 82A-82D. Dk₈₄ can be greater than 6, as one example, and other ranges and Dk values can be relied upon. The cover layer 84 can be embodied two separate insulating layers, and the guide inserts 82A-82D can be arranged and “sandwiched” between the insulating layers, with an adhesive applied between the insulating layers. The insulating layers of the cover layer 84 and the guide inserts 82A-82D can then be passed through a roller or rollers to press and secure the insulating layers of the cover layer 84 together with the adhesive, to hold the guide inserts 82A-82D in place. In another example, the cover layer 84 can be embodied as a single insulating layer, and the insulating layer can be applied and wrapped around (e.g., cigarette wrapped) the guide inserts 82A-82D, with an adhesive applied between top and bottom layers of the insulating layer.

In the example shown in FIG. 7A, each of the guide inserts 82A-82D is formed to have the sectional shape of a rectangle with rounded corners. The ribboned cable 80A can include guide inserts formed to have other shapes, however, such the round guide insert 90, the oblong guide insert 91, or the rounded-endcap guide insert 92, among guide inserts of other shapes. More particularly, each of the guide inserts 82A-82D can be formed to have round, oblong, rounded-endcap, or other guide insert shapes. The ribboned cable 80A can also include guide inserts having different combinations of shapes.

FIG. 7B illustrates an end view of another ribboned waveguide cable 80B (also “ribboned cable 80B”) according to various embodiments of the present disclosure. The ribboned cable 80B is illustrated as a representative example and is not drawn to any particular scale or size. The shape, size, proportion, and other characteristics of the ribboned cable 70B can vary as compared to that shown. For example, the number, size, and shape of the guide inserts in the ribboned cable 80B and other characteristics of the ribboned cable 80B can vary as compared to that shown. The ribboned cable 80B can be formed to any suitable length (e.g., see example length “L” in FIG. 1A). Additionally, in some cases, one or more parts or components of the ribboned cable 80B can be omitted. The ribboned cable 80B can also include other parts or components that are not illustrated in FIG. 7B.

The ribboned cable 80B includes the guide inserts 82A-82D, the cover layer 18, and drain conductors 86A-86C. The ribboned cable 80B shown in FIG. 7B is similar to the ribboned cable 80A shown in FIG. 7A, but the ribboned cable 80B also includes the drain conductors 86A-86C. The drain conductors 86A-86C can be embodied as Copper conductors, Silver-plated Copper conductors, or conductors formed from other metal(s), with or without plating. Each of the drain conductors 86A-86C is positioned centrally between two of the guide inserts 82A-82D, between layers of the cover layer 18. Three (3) drain conductors 86A-86C are shown in FIG. 7B. The ribboned cable 80B can include any suitable number of drain conductors, however, such as four, five, six, seven, eight, nine, ten, eleven, twelve, or more drain conductors. The drain conductors 86A-86C are arranged and secured together in a ribboned or ribbonized format, between the guide inserts 82A-82D, by the cover layer 84.

In the example shown in FIG. 7B, each of the guide inserts 82A-82D is formed to have the sectional shape of a rectangle with rounded corners. The ribboned cable 80B can include guide inserts formed to have other shapes, however, such the round guide insert 90, the oblong guide insert 91, or the rounded-endcap guide insert 92 shown in FIG. 7A, among guide inserts of other shapes. More particularly, each of the guide inserts 82A-82D can be formed to have round, oblong, rounded-endcap, or other guide insert shapes. The ribboned cable 80B can also include guide inserts having different combinations of shapes.

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included. The terms “about” and “substantially,” unless otherwise defined herein to be associated with a particular range, percentage, or related metric of deviation, account at least for some manufacturing tolerances between a theoretical design and a manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure.

What is claimed is:

1. A waveguide cable, comprising:
a first dielectric core;
a second dielectric core;
a first boundary structure positioned and extending along an interface between the first dielectric core and the second dielectric core;
a second boundary structure positioned and extending along the interface between the first dielectric core and the second dielectric core; and
a cover layer that extends around the second dielectric core.

2. The waveguide cable according to claim 1, wherein, along a length of the waveguide cable, the second dielectric core extends entirely around the first dielectric core.

3. The waveguide cable according to claim 1, wherein the first boundary structure comprises a first planar surface and the second boundary structure comprises a second planar surface.

4. The waveguide cable according to claim 1, wherein:
the first boundary structure extends along a first interface region between the first dielectric core and the second dielectric core;
the second boundary structure extends along a second interface region between the first dielectric core and the second dielectric core; and
an inner surface of the first boundary structure faces an inner surface of the second boundary structure.

5. The waveguide cable according to claim 1, wherein:
the first dielectric core comprises a first dielectric material having a first dielectric constant;
the second dielectric core comprises a second dielectric material having a second dielectric constant; and
the first dielectric constant is different than the second dielectric constant.

6. The waveguide cable according to claim 1, wherein:
the first boundary structure comprises a first flat wire; and
the second boundary structure comprises a second flat wire.

7. The waveguide cable according to claim 1, wherein:
the first dielectric core comprises a first dielectric material having a first dielectric constant;
the second dielectric core comprises a second dielectric material having a second dielectric constant;
the first boundary structure and the second boundary structure comprise a third dielectric material having a third dielectric constant;
the first dielectric constant is different than the second dielectric constant; and
the third dielectric constant is greater than the first dielectric constant and the second dielectric constant.

8. The waveguide cable according to claim 1, wherein:
the first dielectric core comprises a first dielectric material having a first dielectric constant;
the second dielectric core comprises a second dielectric material having a second dielectric constant;
the cover layer comprises a third dielectric material having a third dielectric constant;
the first dielectric constant is different than the second dielectric constant; and
the third dielectric constant is greater than the first dielectric constant and the second dielectric constant.

9. The waveguide cable according to claim 1, wherein the cover layer comprises a conductive metal layer.

10. A ribboned waveguide cable, comprising:
a first waveguide cable;
a second waveguide cable; and
a cover layer that extends over the first waveguide cable and the second waveguide cable, wherein the first waveguide cable comprises:
a first dielectric core;
a second dielectric core;
a first boundary structure positioned and extending along an interface between the first dielectric core and the second dielectric core; and
a second boundary structure positioned and extending along the interface between the first dielectric core and the second dielectric core.

11. The ribboned waveguide cable to claim 10, wherein the cover layer comprises a conductive metal layer, and the cover layer ribbonizes the first waveguide cable and the second waveguide cable.

12. The ribboned waveguide cable to claim 10, further comprising a third waveguide cable, wherein the cover layer extends over the first waveguide cable, the second waveguide cable, and the third waveguide cable.

13. The ribboned waveguide cable to claim 10, further comprising a drain conductor between the first waveguide cable and the second waveguide cable, wherein the cover layer extends over the first waveguide cable, the drain conductor, and the second waveguide cable.

14. The ribboned waveguide cable to claim 10, wherein:
the first boundary structure extends along a first interface region between the first dielectric core and the second dielectric core;
the second boundary structure extends along a second interface region between the first dielectric core and the second dielectric core; and
an inner surface of the first boundary structure faces an inner surface of the second boundary structure.

15. The ribboned waveguide cable to claim 10, wherein:
the first boundary structure comprises a first flat wire; and
the second boundary structure comprises a second flat wire.

16. The ribboned waveguide cable to claim 10, wherein:
the first dielectric core comprises a first dielectric material having a first dielectric constant;
the second dielectric core comprises a second dielectric material having a second dielectric constant;
the first boundary structure and the second boundary structure comprise a third dielectric material having a third dielectric constant;
the first dielectric constant is different than the second dielectric constant; and
the third dielectric constant is greater than the first dielectric constant and the second dielectric constant.

17. A ribboned waveguide cable, comprising:
a first waveguide cable;
a second waveguide cable; and
a cover layer that extends over the first waveguide cable and the second waveguide cable, wherein the first waveguide cable comprises:
a first dielectric core;
a second dielectric core; and
first and second boundary structures positioned and extending within the first dielectric core.

18. The ribboned waveguide cable to claim 17, wherein the cover layer comprises a conductive metal layer, and the cover layer ribbonizes the first waveguide cable and the second waveguide cable.

19. The ribboned waveguide cable to claim 17, further comprising a drain conductor between the first waveguide cable and the second waveguide cable, wherein the cover layer extends over the first waveguide cable, the drain conductor, and the second waveguide cable.

20. The ribboned waveguide cable to claim 17, wherein:
the first boundary structure comprises a first flat wire; and
the second boundary structure comprises a second flat wire.
